(19) United States
(12) Patent Application Publication
(10) Pub. No.: US 2020/0273387 A1
(43) Pub. Date: Aug. 27, 2020

(54) DOUBLE DISPLAY WITH COMPACT STRUCTURE

(71) Applicant: PATRICK RUBINSTEIN, Paris (FR)

(72) Inventor: PATRICK RUBINSTEIN, Paris (FR)

(21) Appl. No.: 16/795,893

(22) Filed: Feb. 20, 2020

(30) Foreign Application Priority Data
Feb. 21, 2019 (FR) 19 01721

(51) Int. Cl. G09F 19/14; G02B 27/02

(52) U.S. Cl. CPC G09F 19/14; G02B 27/022

(57) ABSTRACT

A device forming a double display consisting of a panel (1), to the front face of which images (g, d) have been added, drawn or formed in a similar way in the form of strips, the panel being made from a material with a first hardness, the panel being folded in a horizontal direction so that it is corrugated, characterised in that the device also comprises a succession of ribs (4g, 4d) of trapezoidal cross section, the ribs extending to the rear face of the panel, the ribs being made from a material of a second hardness, the second hardness being lower than the first hardness.

### TECHNICAL FIELD

The present invention concerns a device forming a double display, that is a display showing two images, drawings, motifs or similar, one that can be seen when viewed from the left side of the display and the other when viewed from the right side of the display.

### BACKGROUND ART

Normally, for example as described in documents FR 2 947 085 or FR 3 054 069 in the name of the applicant, this type of double display or picture consists firstly of a front sheet, to which images, drawings, motifs, photographs or the like have been added, drawn or formed in a similar way, in the form of strips that form the image when viewed from the left side alternating with strips forming the image when seen from the right side. The sheet is folded to form corrugations of transverse triangular shape comprising apices and troughs, preferably with an angle of 90°, so that the left sides carry the strips corresponding to the image when viewed from the left side and the right sides carry the strips corresponding to the image when viewed from the right side. To this sheet, normally made of cardboard, is also added a backing panel with a shape complimentary to the corrugated sheet made from a more rigid material to provide rigidity to the assembly, the backing panel being for example bonded to the back of the corrugated sheet.

These devices of an old design are complicated and time-consuming to manufacture.

### SUMMARY OF THE INVENTION

The present invention aims to overcome the problems of the old design by proposing a device forming a double display of a simpler structure, which is much easier to manufacture, while providing rigidity that is just as good as in older devices.

The present invention also concerns a process for manufacturing a double display of this type.

According to the invention, a device forming a double display is as defined in claim 1, improvements and the preferred methods of production being defined in sub-claims.

According to a preferred method of production of the invention, rear laminated strips are attached to the upper face of each rib, the material of each rear lamination strip being of a third hardness greater than the second hardness.

Preferably, the first and third hardness are the same.

Preferably, a space without any material is formed between two successive trapezoidal ribs, a pair of alternating ribs, so that the rear face of the panel is exposed.

Preferably, the thickness of the strips is equal to the thickness of the panel, measured in a direction perpendicular to the panel before it is folded.

Preferably, the thickness of the rib, that is the distance between the upper face and the lower face, is greater than the thickness of the panel, measured in a direction perpendicular to the panel before it is folded, in particular from 5 to 15 times greater, in particular 10 times greater.

The present invention also concerns a process for manufacturing a double display, in particular a double display according to the invention, as defined in claim 13.

### BRIEF DESCRIPTION OF THE DRAWINGS

As an example, a preferred method of production of the invention will be described, with reference to drawings in which:

FIG. 1 is a view from above of a display according to the invention.

FIG. 2 is a cross-sectional view on the line A-A of the display in FIG. 1.

FIG. 3 is a cross-sectional view of a laminate used to produce the display in FIGS. 1 and 2,

FIG. 4 is a cross-sectional view of the display in an intermediate state during the production process.

FIG. 5 is a cross-sectional view of a display according to another embodiment of the invention.

FIG. 6 is a cross-sectional view of a display according to yet another embodiment of the invention.

FIG. 7 is a cross-sectional view of another display according to yet another embodiment, at an intermediate stage of its production process.

FIG. 8 is a cross-sectional view of the display in FIG. 7 after folding; and

FIG. 9 is a cross-sectional view of a display of yet another embodiment of the present invention.

### DETAILED DESCRIPTION OF THE INVENTION

FIG. 1 shows a double display according to the invention. Strips carrying left and right images g, d respectively, have been added to the front side of the picture. These images were added directly or by bonding strips, to which drawings, motifs, photographs or the like have been added. The left hand strips g are, because of the corrugation of the front side of the picture, facing towards the left and, from the left side of the picture, only the left hand strips can be seen that together form the first left hand image. When viewed from the right of the picture, only the right hand strips can be seen by the person viewing the picture and together they form the right hand image, which may be different from the left hand image.

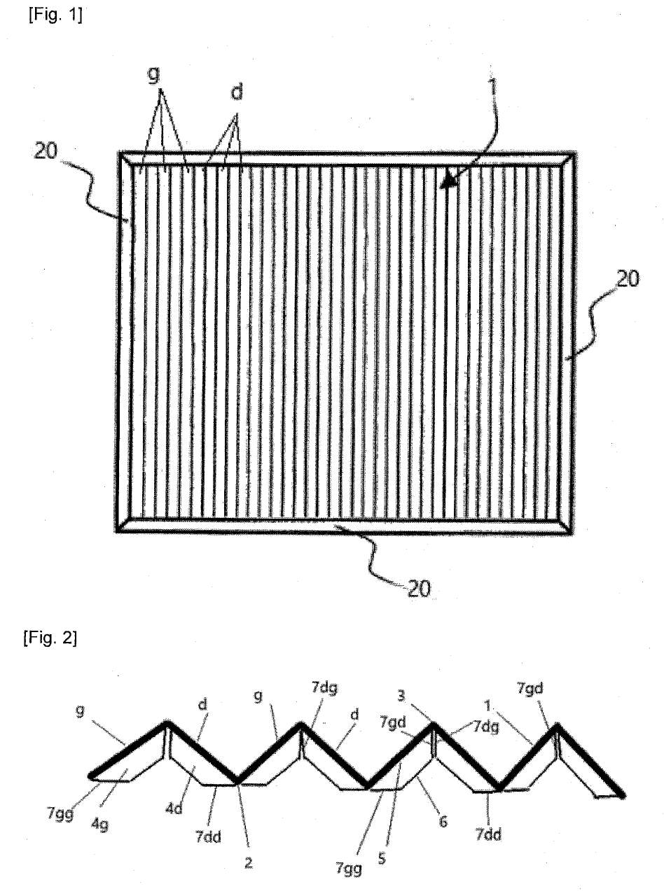

FIG. 2 show, a cross-sectional view on the line A-A of the picture in FIG. 1.

The picture consists of a corrugated front panel 1, the corrugations consisting of troughs 2 and apices 3. In cross-section, the shape of the corrugations is a succession of triangles, preferably essentially at a right angle, angle α in the drawing being close to 90° but which may be between 75 and 105°. On the rear face of the front panel 1 are ribs that are essentially trapezoidal in cross section comprising a basic face 5 fixed to the rear face of the panel 1, for example by bonding or thermoforming, and an opposing outer face consisting of a face 6 forming an apex parallel to the basic face 5 facing towards the rear and two lateral inclined faces 7dd, 7gd; 7gd, 7gg, respectively at the same angle to the horizontal, that is in relation to the front face 5, but at opposite angles, that is the lateral inclined faces 7dd, 7gd; 7gd, 7gg respectively, are oriented so that they converge towards the rear. The angles formed between the lateral inclined faces and the basic 5 and apex 6 faces are preferably the same, so that the ribs 4d, 4g have a trapezoidal, isosceles cross section.

Each rib 4g has a left lateral inclined face 7gg and a right lateral inclined face 7gd. Each rib 4d has a left lateral inclined face 7dg, and a right lateral inclined face 7dd. In general, the angle may be between 30° et 60°, in particular 45°.

Each right lateral inclined face 7gd of each left rib 4g is parallel to the left lateral inclined face 7dg of the right rib 4d immediately following the left rib 4g, in particular being in contact with it, in particular at a right angle to it.

Each left lateral inclined face 7gg of each left rib 4g is arranged parallel to the right lateral inclined face 7dd of the right rib 4d immediately preceding it, in particular, essentially horizontal.

The material used to form the ribs is preferably selected to be less hard than the material selected to form the front panel 1. For example, the front panel 1 may be made from metal, in particular aluminium, but also a thermoplastic material, for example PVC in particular with a high hardness, cardboard or other similar material, while a thermoplastic material for example a Polyethylene or a polypropylene or expanded PVC, cardboard or similar, may be selected to form the ribs.

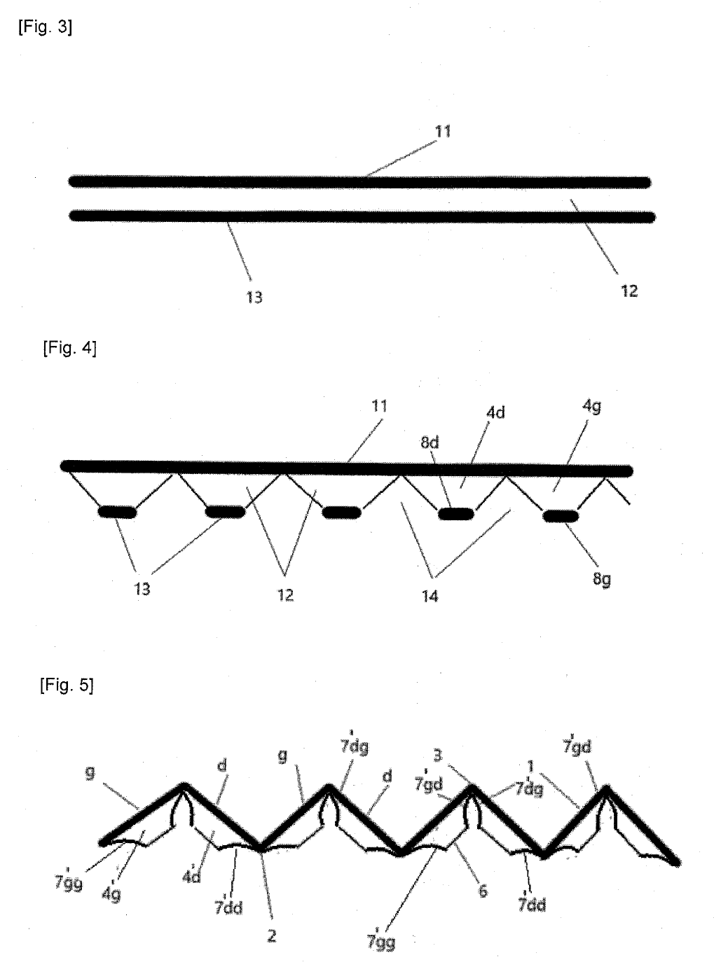

In addition, as shown in FIG. 4, the apex face 6 of each rib may be covered with a layer 8d, 8g respectively of a third material, that is also harder than the second material and with a hardness equal to the hardness of the first material, but this is not essential.

FIG. 5 shows another embodiment of a display according to the invention. Ribs 4′g, 4′d are not essentially trapezoidal, as in the methods of production in FIGS. 1 to 4, they are exactly trapezoidal. Each rib 4′d, 4′g comprises a basic face 5 fixed to the rear face of the panel 1, for example by bonding or thermoforming, and an opposing outer face consisting of a face 6 forming an apex parallel to the basic face 5 facing rearwards and two lateral faces 7′dd, 7′gd, and 7′gd, 7′gg respectively. The difference between the method of production of FIG. 2 and that of FIG. 5 is that in the latter method of production, the lateral faces are not straight but curved inwards in an arc of a circle with their concave sides facing in a direction opposite to the panel 1.

Each right lateral face 7′gd of each left rib 4′g is opposite the lateral left face 7′dg of the right rib 4′d immediately following the left rib 4′g, in particular being in contact with it.

Each lateral left face 7′gg of each left rib 4′g is arranged parallel, or essentially parallel, to the lateral right face 7′dd of the immediately preceding right rib 4′d, in particular essentially horizontal.

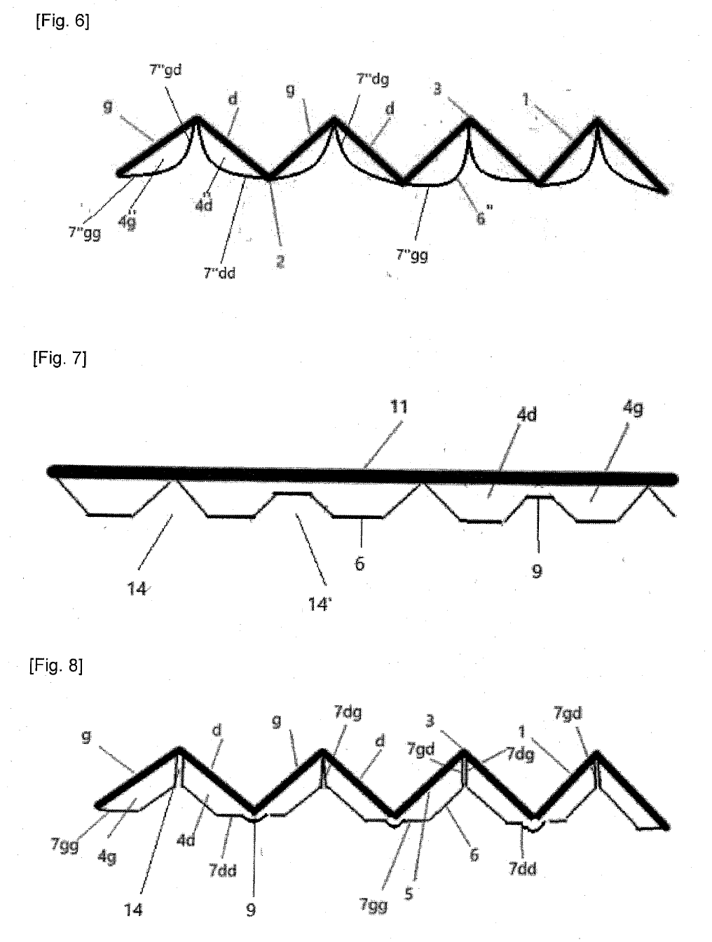

FIG. 6 shows another embodiment of a display according to the invention. Ribs 4″g, 4″d are not trapezoidal, as in the embodiment of FIGS. 1 to 4. Each rib 4″ comprises a basic face 5 fixed to the rear face of the panel 1, for example by bonding or thermoforming, and an outer face forming an arc of a circle with a central apex 6″ and two lateral faces 7″dd, 7″gd and 7″gd, 7″gg respectively, forming arcs of a circle with a curvilinear length half that of the outer face. The lateral faces are curved inwards in an arc of a circle with the concave sides facing the panel 1.

Each lateral right face 7″gd of each left rib 4″g faces the lateral left face 7″dg of the right rib 4″d immediately following the left rib 4″g, in particular being in contact with it.

Each lateral left face 7″gg of each left rib 4″g is arranged parallel, or essentially parallel, to the lateral right face 7″dd of the immediately preceding right rib 4″d.

A simple method for manufacturing a double display, in particular according to the invention will now be described.

To do this, we can start with a laminate 10 (shown in FIG. 3) consisting of an upper layer 11 of a first material with a first hardness, in particular a high hardness, for example metal, for example aluminium, an intermediate layer 12 of a second material of a second hardness, the second hardness being lower than the first hardness, for example a thermoplastic material, and a third layer 13 of a material with a third hardness that is greater than the second hardness but which can be the same as the first hardness. However, the third layer is optional, and the process can be used in its broadest sense with only the two upper 11 and intermediate 12 layers.

Image strips are formed on the upper face of layer 11 intended to form the strips g, d in FIG. 1.

Using a cutter of a suitable size, grooves 14 are cut in the rear face of the laminate 10 spaced apart from each other. For example, in the case of the display in FIG. 1 or 2, these grooves are triangular in shape. The grooves 14, in particular triangular, are produced so that they reach to the rear face of the upper layer 11, until a little of this rear face of layer 11 is exposed. In this way ribs of trapezoidal cross section are formed between the grooves. When the grooves have been produced, the laminate 10 is folded so that each rib comprising a basic face on the side of the rear face of the panel and an opposing outer face comprising, in the case of a triangular groove, an apex face opposite the basic face and two left and right lateral faces extending between the basic and apex faces, the two left and right lateral faces being inclined essentially at the same angle in relation to the basic face, one lateral left face of alternate ribs being in contact, or essentially in contact, or essentially parallel to, the lateral right face of the adjacent, or immediately following rib, the lateral left face of every other rib being essentially parallel to the lateral right face of the adjacent or immediately following rib. This then produces the display shown in FIGS. 1 and 2.

For example, to produce the display in FIG. 5, grooves of cross section in an arc of a circle could be formed, for example, semi-circular instead of triangular grooves. To produce the display in FIG. 6, V-shaped grooves could be formed with branches in an arc of a circle with the concave sides facing the outside of the V.

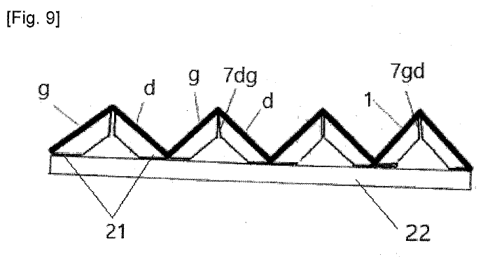

FIGS. 7 and 8 show a display according to a improved embodiment, in particular compared with that in FIG. 2. Whereas in FIG. 2 the triangular grooves 14 are machined to reach the material of the panel 1, in FIG. 7, the grooves 14′ are machined leaving a little of the material of the intermediate layer 12 at the bottom in alternate grooves, the other grooves 14 (also alternate) bring produced as in the method of production in FIG. 2. The grooves 14′ therefore have a flat bottom 9. This produces a stronger display.

All the left and right lateral straight faces respectively of the grooves are mutually parallel, but for alternate grooves 14′, the lateral faces are stopped at a distance from the panel 1 thereby leaving one thickness of the intermediate material between the groove 14′ and the panel 1. For example, a thickness of the intermediate material of the order of 0.2 to 0.3 mm could be left giving a flat bottom for the groove 14′ of the order of millimetres.

FIG. 8 shows the display in FIG. 7 in the intermediate state after forming the grooves and before folding. As can be seen, the material of the intermediate layer 12 between the base 9 and the panel 1, after folding, forms at the base of the display, a kind of protective bulge that reinforces the bases.

The principle of leaving a little of the intermediate material in alternate grooves to make the display stronger can also be applied to the other methods of manufacture described in the present application.

For the front panel 1, a thickness (measured, at each point, in a direction perpendicular to the panel 1, that is perpendicular to the plane of the image g or d) of between 0.1 and 1 mm can be selected, in particular between 0.2 and 0.5 mm. For the intermediate layer 12, a thickness of between 1 and 5 mm could be selected, for example 2.5 mm. For the third layer 13, a thickness preferably equal to that of the front panel 1 could be selected, for example between 0.1 and 0.5 mm, for example, 0.2 mm.

As shown in the figures, the panel may be surrounded by a frame 20.

In FIG. 9, it is represented another embodiment of the present invention, implementing, relative to the embodiment of FIG. 2, an improvement. This same improvement may be also implemented in each of the other embodiments of FIGS. 4 to 8. In FIG. 9, it has been added on the rear face of the device (that is on the side opposite the images) a supplemental panel 22, adhesively fixed by respective adhesive layers to the lateral faces 7dd and 7gg of the ribs, so as to rigidify even more the device, and notably to make sure of the good stability of the angle of the corners of the throughs and apices 2 and 3.

In replacement of the panel 22, one could provide for a resin or glue layer which would fill up the spaces of triangular cross-section which are formed in the rear face of the device, so as to, one the resin hardened, maintain the stability of the angle of the corners, notably at around 90°, which is the most appropriate value for an optimized vision of the two left and right images.

To provide the panel 22 or a layer of resin or any other analogous system to maintain the stability of the angle of the corners is particularly useful in the case where the selected materials for the panel 1, for the ribs and optionally for the rear laminations, do not have a high hardness, for example when the panel 1 is made of PVC and the ribs are made of expanded PVC.

In the present application, production methods using all identical grooves have been described. However, grooves of different shapes from each other could also be used, while remaining within the scope of the present invention, for example making every other groove triangular, and alternate grooves an arc of a circle. Furthermore, the shape of the lateral surfaces is not limited to straight segments or arcs of a circle, and other shapes can be provided while remaining within the scope of the present invention.

1. A device forming a double display comprising a panel (1), to the front face of which have been added designs or shapes formed in a similar way to the images (g, d) in the form of strips, some strips extending in a vertical direction and strips alternating between so-called left strips and right strips, all the left strips together corresponding to an image, drawing, motif, photograph or the like intended to be viewed from the left side and right strips together corresponding to an image, drawing, motif, photograph or the like intended to be viewed from the right side, the panel being folded in a horizontal direction so as to be corrugated, the cross section of the corrugations being triangles or corners, each corner shape having a left side and a right side, the set of left sides bearing left strips and the set of right sides bearing right strips, characterised in that the device also comprises a succession of ribs (4g, 4d, 4′g; 4′d, 4″g, 4″d) extending on the rear face of the panel, each rib comprising a basic face (5) on the side of the rear face of the panel and an outer face (6, 7gg, 7gd, 7dg, 7dd; 6, 7′gg, 7′gd, 7′dg, 7′dd; 6″, 7″gg, 7″gd, 7″dg, 7″dd) opposite the basic face, the outer face comprising an apex (6; 6″) and two lateral left and right faces (7gg, 7gd, 7dg, 7dd; 7′gg, 7′gd, 7′dg, 7′dd; 7″gg, 7″gd, 7″dg, 7″dd) extending between the basic face and the apex (6; 6″), a lateral left face (7dg; 7′dg; 7″dg) of alternate ribs facing or essentially facing the lateral right face (7gd; 7′gd; 7″gd) of the adjacent or immediately following rib, in particular being in mutual contact, while the lateral left face (7gg; 7′gg; 7″gg) of the alternate rib is aligned, or essentially aligned with the lateral right face (7dd; 7′dd; 7″dd) of the adjacent, or immediately following rib.

2. A device forming a double display according to claim 1, characterised in that each rib has a trapezoidal cross section, the outer face comprising a straight face forming the apex (6) opposite to the basic face and two lateral left and right straight faces (7gg, 7gd, 7dg, 7dd) extending between the basic and apex faces, the two lateral straight left and right faces being inclined in relation to the basic face (5) and the face forming the apex (6), a left lateral face (7dg) of every other rib being in contact, or essentially in contact or essentially parallel to the lateral right face (7gd) of the adjacent, or immediately following rib, while the left lateral face (7gg) of alternate ribs is aligned, or essentially aligned, with the right lateral face (7dd) of the adjacent or immediately following rib.

3. A device according to claim 2, characterised in that the two lateral straight left and right faces are inclined by essentially the same angle with respect to the basic face and the apex face (6).

4. A device according to claim 2, characterised in that the panel is made from a material of a first hardness, preferably a high hardness, for example a metal, for example aluminium, and the ribs being made from a material of a second hardness, the second hardness being lower than the first hardness, for example thermoplastic, for example polyethylene or polypropylene or the like.

5. A device according to claim 1, characterised in that the rear laminations (8g, 8d) are fixed to the apex (6) of the outer face of each rib of the trapezoidal section, the material of each rear lamination being of a third hardness, the third hardness being greater than the second hardness.

6. A device according to claim 5, characterised in that the first and third hardness are the same.

7. A device according to claim 1, characterised in that between two successive ribs, in particular trapezoidal ribs, a pair of alternate ribs are fitted, forming a space with no material so that the rear face of the front panel is exposed.

8. A device according to claim 1, characterised in that a region (9) with material is formed between two successive ribs, in particular trapezoidal ribs, so that the rear face of the front panel is not exposed.

9. A device according to claim 2, characterised in that the angle at the apex of the corner shape is between 75 and 105°, in particular about 90°.

10. A device according to claim 2, characterised in that the trapezoidal section is isosceles.

11. A device according to claim 5, characterised in that the thickness of the laminations is equal to the thickness of the panel, measured in a direction perpendicular to the panel in its unfolded state.

12. A device according to claim 1, characterised in that the thickness of the ribs, that is the distance from the crest to the basic face is greater than the thickness of the panel, measured in a direction perpendicular to the panel in its unfolded state, in particular from 5 to 15 times greater, in particular 10 times greater.

13. A process for manufacturing a double display, in particular according to one of the preceding claims, comprising stages in which:
a panel consisting of a laminate is taken, the laminate being formed by the superposition of at least two layers, an upper layer (11) in a first material, in particular with a first hardness, in particular a high hardness, for example metal, for example aluminium and a lower layer (12) of material of a second hardness lower than the first hardness, for example a thermoplastic material formed into the classical shape of a rectangular or square panel to which is added or drawn or formed in a similar way images, drawings, motifs, photographs or the like, in the form of strips parallel to each other in a vertical direction, the strips alternating between left strips and right strips, a set of the said left strips corresponding to a first image intended to be viewed from the left side and a set of right strips corresponding to a second image, preferably different from the first image, intended to be viewed from the right side;
Grooves (14; 14, 14′), in particular of triangular cross section are machined, extending to a distance from each other in a vertical direction in the rear face of the lower layer (12) of the laminate, so that the bottoms of the grooves, in particular the bottoms of each groove, are formed by the exposed material of the lower face of the upper layer (11), the bottoms of the grooves being positioned to correspond to the lines of demarcation between two successive left and right strips, and;
the laminate is folded so that ribs (4g, 4d; 4′g,4′d; 4″g,4″d) are formed between two successive grooves (14; 14, 14′), in particular of triangular section, each comprising a basic face (5) to the side of the rear face of the layer (11) and an outer face comprising an apex (6; 6″) opposite the basic face and two left and right lateral faces (7gd, 7gg, 7dg, 7dd; 7′gd, 7′gg, 7′dg, 7′dd; 7″gd, 7″gg, 7″dg, 7″dd) extending between the basic face and the apex, a left lateral face of alternate ribs facing, or essentially facing, the lateral right face of the adjacent, or immediately following rib, the left lateral face of alternate ribs being aligned, or essentially aligned, with the right lateral face of the adjacent, or immediately following rib, thus producing the final display.

14. A process for manufacturing a double display according to claim 13, characterised in that in alternate grooves (14′), material of the layer (12) is left between the bottom (9) of the groove and the layer (11).

15. A process for manufacturing a double display according to claim 13, characterised in that in, material of the layer (12) is not left at the bottom of alternate grooves, so that the layer (11) is exposed.
